(19) United States
(12) Patent Application Publication
(10) Pub. No.: US 2005/0100503 A1
(43) Pub. Date: May 12, 2005

(54) Method of decomposing gypsum to sulfur dioxide and the apparatus thereof

(76) Inventors: Yisheng Feng, Wudi County (CN); Jiutian Feng, Wudi County (CN); Xigang Liu, Wudi County (CN); Yurui Wang, Wudi County (CN); Tianbao Lu, Wudi County (CN)

Correspondence Address: LACKENBACH SIEGEL, ONE CHASE ROAD, SCARSDALE, NY, 10583, US

(21) Appl. No.: 10/363,435

(22) PCT Filed: May 18, 2001
(86) PCT No.: PCT/CN01/00811

(30) Foreign Application Priority Data
Sep. 1, 2000 (CN) 001113291

(51) Int. Cl. C01B 17/52; F27B 7/00

(52) U.S. Cl. 423/542; 422/168; 422/173

(57) ABSTRACT

A method of decomposing gypsum to sulfur dioxide, and the apparatus thereof are disclosed. The apparatus comprises a set of four-stage cyclone preheater and a rotary kiln for decomposing and calcining. In the four-stage cyclone preheater, the off-gas of the kiln conducts heat-exchange with materials. By such processing, the efficiency of heat exchange is high, and gypsum which contains 10-25% of water can be directly used for preparing crude materials. The entrance temperature of the preheated materials can be up to 600-720° C., while the temperature of the off-gas can be decreased to 260-400° C., so that heat utilization ratio is high, and the cost of the apparatus can be cut down. The concentration of SO₂ in the off-gas may be up to 11-14%, so that two-conversion two-adsorption process can be employed for preparing sulfuric acid.

### TECHNICAL FIELD

The present invention relates to a method of producing sulfur dioxide and the apparatus thereof. Particularly, the invention relates to a method of decomposing gypsum to sulfur dioxide and the apparatus thereof.

### BACKGROUND ART

The patent CN106598B has disclosed that gypsum is preheated and baked up by the gas of flue which temperature is 600-750° C. until the total amount of water in gypsum is down to 4-6%; further steps comprise blending, decomposing and calcining; finally, sulfur dioxide and cement can be obtained.

Linz Chemical Co. Ltd. in Austria has proposed to install a four-stage preheater with a vertical tub at the end of the rotary kiln. In such apparatus the washed phosphate rock (intermingled amount: 70%) can be dehydrated and dried until it contains 6-8% of water, and then it is mixed with pulverized and dried nature anhydrous gypsum, sand and coke to form crude materials. The crude materials are preheated by a four-stage preheater with a vertical tub until its temperature is up to 650-700° C., and then is transferred into rotary kiln to be decomposed and calcined. At the end of kiln the temperature of gas into the preheater is 800-850° C.; the temperature of the gas discharged from the preheater is 425-430° C. Although the preheater, to some extent, can reduce the heat consumption, heat-exchange efficiency of the preheater with a vertical tub is low, and the preheater may be plugged up; furthermore, heat utilization rate of rotary kiln is low, and the yield per tankage of kiln is low, the volume concentration of SO₂ in the off-gas is low, generally 7-9%, and only the one-conversion one-adsorption process can be employed, which results in that for the system of preparing sulfuric acid a large amount of gas need to be treated and the ability of manufacture is low.

### DISCLOSURE OF THE INVENTION

One purpose of the invention is providing a method of decomposing gypsum to sulfur dioxide, by which the concentration of sulfur dioxide is higher, heat utilization rate is high and procedures are more simple;

The other purpose of the invention is providing a apparatus of decomposing gypsum to sulfur dioxide.

The present invention relates to a method of decomposing gypsum to sulfur dioxide, which includes:
The crude gypsum materials are mixed with the off-gas discharged from the second cyclone preheater, and then transferred into the first cyclone preheater; subsequently, the sulfur dioxide is discharged from the top of the preheater;
The separated solid materials fall down by their weight, and are mixed with the off-gas discharged from the third cyclone preheater, and then are transferred into the second cyclone preheater to be preheated and separated;
The separated solid materials from the second cyclone preheater are mixed with the off-gas discharged from the fourth cyclone preheater, and then are transferred into the third cyclone preheater to be preheated and separated;
The separated solid materials from the third cyclone preheater are transferred into the fourth cyclone preheater and preheated by the off-gas from the end of the rotary kiln, and finally are transferred into the rotary kiln to be decomposed and calcined.

In the method of decomposing gypsum to sulfuric acid, which is mentioned above, the temperature of the off-gas, from the end of the rotary kiln and into the fourth preheater, is 800-900° C., and the temperature of the materials, preheated by the fourth preheater is 600-720° C. while entering into the kiln. The temperature of the off-gas from the first cyclone preheater is 260-400° C., and the concentration of sulfur dioxide in the off-gas is 11-14 vol % in a dry state.

The present invention also relates to an apparatus of decomposing gypsum to sulfur dioxide. The apparatus comprises a set of four-stage cyclone preheater and a rotary kiln for decomposing and calcining. The method used in conjunction with the apparatus is:
The crude gypsum materials are mixed directly with the off-gas discharged from the second cyclone preheater, and then transferred into the first cyclone preheater; the sulfur dioxide is discharged from the top of the preheater;
The separated solid materials fall down by their weight and are mixed with the off-gas discharged from the third cyclone preheater, and then are transferred into the second cyclone preheater to be preheated and separated;
The separated solid materials from the second cyclone preheater are mixed with the off-gas discharged from the fourth cyclone preheater, and then are transferred into the third cyclone preheater to be preheated and separated;
The separated solid materials from the third cyclone preheater are transferred into the fourth cyclone preheater and are preheated by the off-gas from the end of the rotary kiln, and then are transferred into the rotary kiln to be decomposed and calcined.

In the apparatus of decomposing gypsum to sulfuric acid, which is mentioned above, the fourth preheater is a boiling preheater.

### BRIEF DESCRIPTION OF THE DRAWINGS

FIG. 1 is a schematic diagram of the apparatus of decomposing gypsum to sulfur dioxide and the process thereof.

FIG. 2 is a schematic diagram of the combined system of decomposing gypsum to sulfur dioxide and cement.

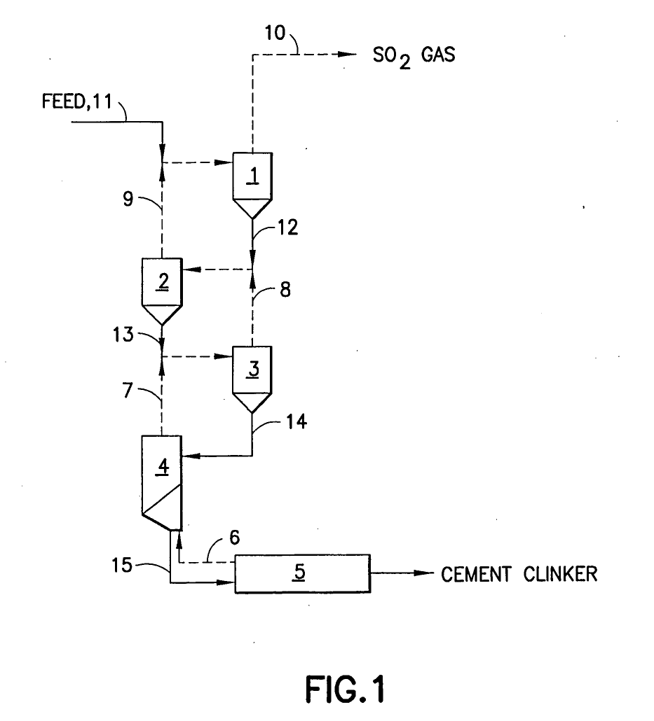

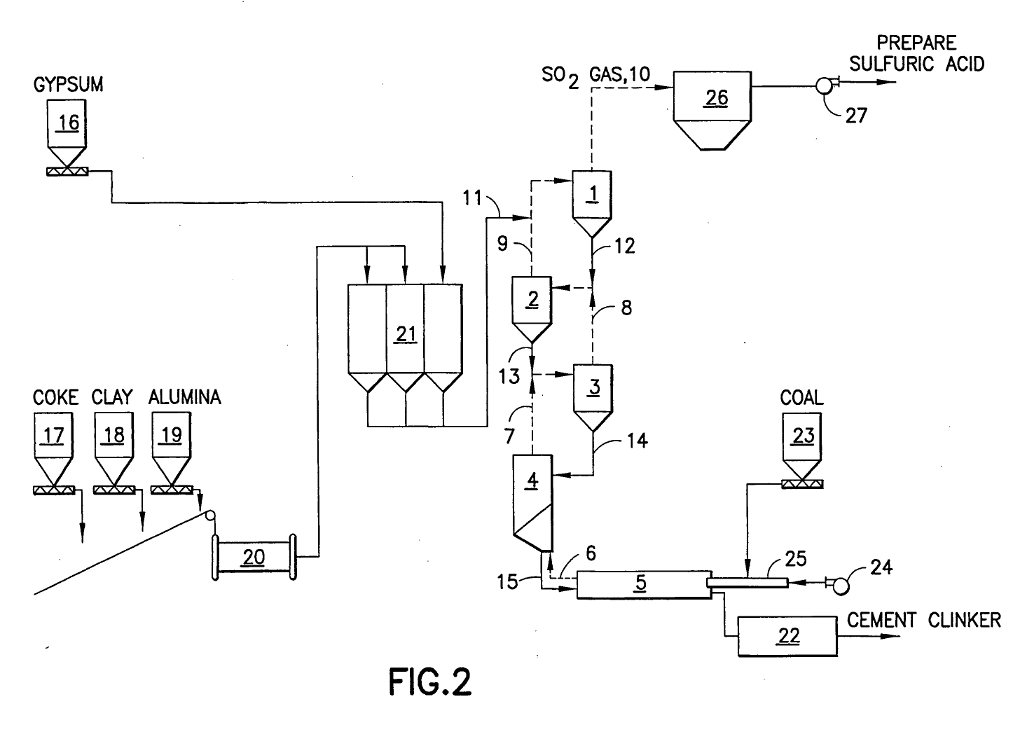

FIG. 1 is one part of the apparatus showed in FIG. 2. The invention can be described by the following description of FIG. 2 in detail.

Please refer to FIG. 2. Gypsum 16 in which the amount of water is 10-25% water, together with coke 17, clay 18 and alumina 19 pulverized by ball grinder 20, are fed into blending cabin 21. The blended crude materials 11 is mixed with off-gas 9 discharged from the second cyclone preheater 2, and then is transferred into the first cyclone preheater 1, where the gas is separated from the solid. The concentration of sulfur dioxide in the off-gas 10 discharged from the top of the first preheater 1 is 11-14 vol % in a dry state, and the temperature of the off-gas 10 is 260-400° C. After passing an electric dust catcher 26, the off-gas 10 is transferred by a fan 27 into the manufacture section for preparing sulfuric acid. The solid materials 12 separated by the first cyclone preheater 1 are mixed with the off-gas 8 discharged from the third cyclone preheater 3, and then are transferred into the second cyclone preheater 2, where the gas is separated from the solid. The separated solid materials 13 are mixed with the off-gas 7 discharged from the fourth cyclone preheater 4, and then are transferred into the third cyclone preheater 3, where the gas is separated from the solid. The separated solid materials 14 from the third cyclone preheater 3 are transferred into the fourth cyclone preheater 4, and exchange heat in the preheater with the off-gas 6 discharged from the end of rotary kiln 5 in a boiling form. Then the solid materials 15 are transferred into the rotary kiln 5 to be decomposed and calcined so as to obtain cement clinker. The obtained cement clinker is cooled by a cooler 22, and is pulverized to form cement. The coal 23 as fuel of the rotary kiln is transferred into the rotary kiln by fan 24 and bunker 25, and burns in the kiln.

### PREFERRED EMBODIMENTS OF THE INVENTION

### EXAMPLE 1

The gypsum, which contains 24.53% of water (crystalline water: 19.12% adsorptive water: 5.41%), is mixed with coke, clay and alumina pulverized by ball grinder in the ratio of 100:8:10:6 (by weight) to prepare blended crude materials. The blended crude materials are fed (55 ton/h) into the system of cyclone preheater and are mixed with off-gas discharged from the second cyclone preheater (diameter: φ3370 mm), which temperature is 405° C., and then are transferred into the first cyclone preheater (φ2500 mm, two set), where the gas is separated from the solid. The concentration of sulfur dioxide in the off-gas discharged from the top of the first preheater is 12.1 vol % in a dry state, and the temperature of the off-gas is 313° C. After passing an electric dust catcher, the off-gas is transferred by a fan into the manufacture section for preparing sulfuric acid by employing two-conversion two-adsorption process. The solid materials, which temperature is 265° C., separated by the first cyclone preheater, are mixed with the off-gas, which temperature is 634° C., discharged from the third cyclone preheater (φ3650 mm), and then are transferred into the second cyclone preheater, where the gas is separated from the solid. Similarly, the separated solid materials which temperature is 395° C., separated by the second cyclone preheater, are mixed with the off-gas, which temperature is 659° C., discharged from the fourth cyclone preheater (φ3650 mm), and then are transferred into the third cyclone preheater, where the gas are separated from the solid. The solid materials, which temperature is 515° C., separated by the third cyclone preheater, are transferred into the fourth cyclone preheater, and then exchange heat in a boiling form with the off-gas, which temperature is 854° C., discharged from the rotary kiln. Then the crude materials which temperature is 663° C. are transferred into the rotary kiln to be decomposed and calcined to obtain cement clinker. The obtained cement clinker is cooled by a cooler, and pulverized to form cement. The coal as a fuel of the rotary kiln is transferred into the rotary kiln by fan and bunker, and then burns in the kiln.

### EXAMPLE 2

The gypsum, which contains 22.19% of water (crystalline water: 18.95%, adsorptive water: 3.24%) is mixed with coke, clay and alumina pulverized by ball grinder in the ratio of 100:8:10:6 (by weight) to prepare blended crude materials. The blended crude materials are fed (58 ton/h) into the system of cyclone preheater and are mixed with off-gas, which temperature is 423° C., discharged from the second cyclone preheater (φ3370 mm), and then are transferred into the first cyclone preheater (φ2500 mm, two set), where the gas is separated from the solid. The concentration of sulfur dioxide in the off-gas discharged from the top of the first preheater is 13.1 vol % in a dry state, and the temperature of the off-gas is 286° C. After passing an electric dust catcher, the off-gas is transferred by a fan into the manufacture section for preparing sulfuric acid by employing two-conversion two-adsorption process. The solid materials, which temperature is 261° C., separated by the first cyclone preheater, are mixed with the off-gas, which temperature is 589° C., discharged from the third cyclone preheater (φ3650 mm), and then are transferred into the second cyclone preheater, where the gas is separated from the solid. Similarly, the separated solid materials from the second cyclone preheater, which temperature is 403° C. are mixed with the off-gas which temperature is 686° C., discharged from the fourth cyclone preheater (φ3650 mm), and then are transferred into the third cyclone preheater, where the gas are separated from the solid. The solid materials, which temperature is 537° C., separated by the third cyclone preheater, are transferred into the fourth cyclone preheater, and then exchange heat in a boiling form with the off-gas, which temperature is 884° C., discharged from the rotary kiln. Then the solid materials which temperature is 685° C. are transferred into the rotary kiln to be decomposed and calcined to obtain cement clinker. The obtained cement clinker is cooled by a cooler, and is pulverized to form cement. The coal as a fuel of the rotary kiln is transferred into the rotary kiln by fan and bunker, and then burns in the kiln.

Industrial Applicability

The present invention has obvious advantages. The invention uses cyclone preheater to conduct heat-exchange between the materials and off-gas. By such process, the efficiency of heat exchange is high, and materials can't cling or conglutinate on the wall. Therefore, the gypsum which contains 10-25% water can be directly used for preparing crude materials and needn't to be dried and dehydrated, and consequently the baking procedure can be omitted, which can cut down the cost of the apparatus.

The temperature of the preheated materials can be up to 600-720° C. The temperature of materials entering into the kiln is high, which can reduce the consumption of the fuel in the rotary kiln and save energy. Meanwhile, the temperature of the off-gas from the end of the rotary kiln can be decreased from 800-900° C. to 260-400° C. by four-stages heat-exchange, and then can be applied to prepare sulfuric acid, so that the loss of heat is reduced.

In the present invention, the concentration of SO₂ in the off-gas may be up to 11-14%, so that two-conversion two-adsorption process can be employed for preparing sulfuric acid. The overall conversion rate may be up to 99.5%, and its absorption rate may be up to more than 99.95%. Therefore, the invention has obvious advantages in the aspect of economy and society.

1. A method for decomposing gypsum to sulfur dioxide, characterized in that the method comprises the steps of:
crude gypsum materials are mixed with off-gas discharged from the second cyclone preheater, and then are transferred into a first cyclone preheater; subsequently sulfur dioxide is discharged from the top of the first cyclone preheater;
The separated solid materials fall down by their weight and are mixed with off-gas discharged from a third cyclone preheater, and then are transferred into the second cyclone preheater to be preheated and separated;
The separated solid materials from the second cyclone preheater are mixed with the off-gas discharged from a fourth cyclone preheater, and then are transferred into the third cyclone preheater to be preheated and separated;
The separated solid materials from the third cyclone preheater are transferred into the fourth cyclone preheater and are preheated by off-gas from the end of the rotary kiln, and then are transferred into the rotary kiln to be decomposed and calcined.

2. A method in accordance with claim 1, characterized in that the temperature of the off-gas, which is from the end of the rotary kiln and then enters into the fourth preheater, is 800-900° C.; the temperature of the crude materials entering into the kiln, preheated by the fourth preheater, is 600-720° C.

3. A method in accordance with claim 1, characterized in that the temperature of the off-gas discharged from the first cyclone preheater is 260-400° C.; the concentration of sulfur dioxide is 11-14 vol % in a dry state.

4. A apparatus for decomposing gypsum to sulfur dioxide, characterized in that the apparatus comprises a set of four-stage cyclone preheater and a rotary kiln for decomposing and calcining, wherein the method used in conjunction with the apparatus is:
crude gypsum materials are mixed with the off-gas discharged from the second cyclone preheater, and then are transferred into the first cyclone preheater; and subsequently the sulfur dioxide is discharged from the top of the preheater;
The separated solid materials fall down by their weight and are mixed with the off-gas discharged from the third cyclone preheater, and then are transferred into the second cyclone preheater to be preheated and separated;
The separated solid materials by the second cyclone preheater are mixed with the off-gas discharged from the fourth cyclone preheater, and then are transferred into the third cyclone preheater to be preheated and separated;
The separated solid materials from the third cyclone preheater are transferred into the fourth cyclone preheater and are preheated by the off-gas from the end of the rotary kiln, and then are transferred into the rotary kiln to be decomposed and calcined.

5. An apparatus in accordance with claim 4, characterized in that, the fourth preheater is a boiling preheater.
